(19) United States
(12) Patent Application Publication
(10) Pub. No.: US 2026/0055305 A1
(43) Pub. Date: Feb. 26, 2026

(54) ELECTRICALLY CONDUCTIVE PRESSURE SENSITIVE ADHESIVES CONTAINING NANOPARTICLE ADDITIVES

(71) Applicant: 3M INNOVATIVE PROPERTIES COMPANY, St. Paul, MN (US)

(72) Inventors: Jing Fang, Shanghai (CN); Jie Huang, Shanghai (CN); Claire Hartmann-Thompson, Lake Elmo, MN (US); Shane White, Stillwater, MN (US); Jeffrey McCutcheon, Baldwin, WI (US)

(21) Appl. No.: 19/099,529

(22) PCT Filed: Aug. 26, 2022
(86) PCT No.: PCT/CN2022/115182

§ 371 Date: Jan. 29, 2025

(51) Int. Cl. C09J 9/02; B32B 7/06; B32B 7/12; C09J 7/25; C09J 7/38; C09J 11/04

(52) U.S. Cl. CPC C09J 9/02; B32B 7/06; B32B 7/12; C09J 7/255; C09J 7/385; C09J 7/387; C09J 11/04; C09J 2301/302; C09J 2301/314; C09J 2301/408; C09J 2301/414; C09J 2467/006

(57) ABSTRACT

Conductive adhesives include a pressure sensitive adhesive composition, electrically conductive particles dispersed within the pressure sensitive adhesive composition, and at least one nanoparticle additive dispersed within the pressure sensitive adhesive composition. The conductive adhesive is a pressure sensitive adhesive with a DC Resistance of less than or equal to 0.21 ohms as measured as a tape with a conductive backing using a PIM board and can be tested for PIM (passive intermodulation), such that the measured PIM level for the conductive adhesive is lower than the identical conductive adhesive without the additive.

### FIELD OF THE DISCLOSURE

The current disclosure relates to electrically conductive pressure sensitive adhesives and articles prepared with these pressure sensitive adhesives.

### BACKGROUND

A wide range of adhesives and adhesive articles are used in optical and electronic applications. These adhesive articles include pressure sensitive adhesives as well as structural and semi-structural adhesives.

In electronic assembly devices such as smart phones and tablets, there are many applications that need conductive tapes and conductive gaskets to work as grounding and/or shielding materials. Conductive pressure sensitive adhesives (CPSAs) and articles that contain CPSAs are among the components used in the electronic devices. These CPSAs are used not only to adhere elements of the devices together (the typical role of PSAs), but also are called upon to provide additional roles within the device. Conductive PSAs have contradictory requirements, typically they need to have high electrical conductivity for grounding performance and adhere strongly to electrical components without adversely affecting the electrical components.

### SUMMARY

Disclosed herein are electrically conductive adhesives that contain nanoparticle additives and articles prepared from these conducive adhesives. The conductive adhesives comprise a pressure sensitive adhesive composition, electrically conductive particles dispersed within the pressure sensitive adhesive composition, and at least one additive dispersed within the pressure sensitive adhesive composition, where the additive comprises conductive nanoparticles. The conductive adhesive is a pressure sensitive adhesive with a DC Resistance of less than or equal to 0.21 ohms as measured as a tape with a conductive backing using a PIM board and can be tested for PIM (passive intermodulation) as described herein, such that the measured PIM level for the conductive adhesive is lower than the identical conductive adhesive without the additive.

Also disclosed herein are electrically conductive articles comprising a substrate with a first major surface and a second major surface, and an electrically conductive adhesive layer disposed on at least a portion of the second major surface of the substrate. The electrically conductive adhesive is described above.

### BRIEF DESCRIPTION OF THE DRAWINGS

The present application may be more completely understood in consideration of the following detailed description of various embodiments of the disclosure in connection with the accompanying drawings.

FIG. 1 is a cross sectional view of a device for testing PIM (passive intermodulation) of adhesives.

FIG. 2 is a cross sectional view of another device for testing PIM (passive intermodulation) of adhesives.

FIG. 3 is a cross sectional view of another device for testing PIM (passive intermodulation) of adhesives.

### DETAILED DESCRIPTION

In electronic assembly devices such as smart phones and tablets, there are many applications that need conductive tapes and conductive gaskets to work as grounding and/or shielding materials. Conductive pressure sensitive adhesives (CPSAs) and articles that contain CPSAs are among the components used in the electronic devices. These CPSAs are used not only to adhere elements of the devices together (the typical role of PSAs), but also are called upon to provide additional roles within the device. Conductive PSAs have contradictory requirements, typically they need to have high electrical conductivity for grounding performance and adhere strongly to electrical components without adversely affecting the electrical components.

One need in electronic devices is for a reduction in passive intermodulation (PIM). PIM is generated when two or more signals at different frequencies mix with each other due to electrical nonlinearities. In some cases, the PIM signal resulting from wireless transmission of a signal can occur at a frequency inside a receiving band of the wireless communication or data device, thereby causing undesired signal interference. Methods for measuring PIM are described below and are shown in the Figures. Therefore, the need remains for conductive PSAs that maintain good PSA properties (such as peel and shear properties), good conductive properties, and provide a decrease in PIM.

In this disclosure, CPSAs are described that provide good PSA properties (such as peel and shear properties), good conductive properties, and provide a decrease in PIM. The CPSAs comprise a pressure sensitive adhesive composition, conductive particles dispersed within the pressure sensitive adhesive composition, and at least one additive dispersed within the pressure sensitive adhesive composition, where the additive comprises conductive nanoparticles. Also disclosed are articles prepared using this conductive pressure sensitive adhesive. Among the articles are single-sided tape articles and double-sided tape articles. Single-sided tape articles are those that include the CPSA coated on a substrate, typically a conductive substrate. Double-sided tape articles also sometimes called “transfer tapes”, include adhesive coated on both sides of substrate, typically a conductive substrate. In this way, both exposed surfaces of the article have CPSA surfaces.

The term “adhesive” as used herein refers to polymeric compositions useful to adhere together two adherends. Examples of adhesives are pressure sensitive adhesives, semi-structural adhesives and structural adhesives.

Pressure sensitive adhesive compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. Obtaining the proper balance of properties is not a simple process.

Structural adhesives refer to adhesives that that can bond strongly and permanently to adherends so that the adhesive bond strength is in excess of 6.0 MPa (1000 psi).

Semi-structural adhesives are those with properties intermediate between PSAs and structural adhesives. Semi-structural adhesives bond strongly to adherends but have adhesive bond strengths that are less than structural adhesives.

The term “(meth)acrylate-based” refers to polymers that contain at least (meth)acrylates and may also contain co-polymerizable monomers. As used herein, “(meth)acrylate” when referring to monomers, refers to monomeric acrylic or methacrylic esters of alcohols.

The terms “room temperature” and “ambient temperature” are used interchangeably to mean temperatures in the range of 20° C. to 25° C.

The term “adjacent” as used herein when referring to two layers means that the two layers are in proximity with one another with no intervening open space between them. They may be in direct contact with one another (e.g. laminated together) or there may be intervening layers.

The terms “polymer” and “macromolecule” are used herein consistent with their common usage in chemistry. Polymers and macromolecules are composed of many repeated subunits. The term “polymer” is used to describe the resultant material formed from a polymerization reaction.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

Disclosed herein are conductive adhesives. The conductive adhesives comprise a pressure sensitive adhesive composition, electrically conductive particles dispersed within the pressure sensitive adhesive composition, and at least one additive dispersed within the pressure sensitive adhesive composition, where the additive comprises conductive nanoparticles. The conductive adhesive is a pressure sensitive adhesive with a DC Resistance of less than or equal to 0.21 ohms as measured using a PIM board and can be tested for PIM (passive intermodulation) in a variety of ways as is described in greater detail below, in the Examples section and in the Figures. One method involves forming a tape, the tape comprising a layer of the conductive adhesive and an electrically conductive layer such as a conductive non-woven layer. The tape is placed in a test fixture comprising gold conductive surfaces. When first and second electrical signals propagate in the thickness direction of the conductive adhesive layer between the gold surfaces at respective frequencies F1 and F2, any intermodulation signal generated from the first and second electrical signals has a frequency F3 equal to nF1+mF2, where m and n positive or negative integers. The current conductive adhesive has a measured PIM level that is lower than the measured PIM level for an identical conductive adhesive without the additive. In some embodiments, the conductive adhesive has a 180° Peel Adhesion of at least 10.0 Newtons/decimeter (or 0.10 N/mm) at Room Temperature, when the conductive adhesive is disposed on a 50-micrometer thick PET (polyethylene terephthalate) backing. Each of these components and features are described in greater detail below.

It should be noted that properties of the adhesive such as 180° Peel Adhesion, DC resistance, and PIM level are properties of the conductive adhesive. While the conductive adhesive is for example formed into a tape by disposing the adhesive onto a 50 micrometer PET backing for 180° Peel Adhesion testing, the property is a property of the adhesive itself and does not mean that the adhesive is in the form of a tape or needs to be used in the form of a tape. The method of testing involves the formation of a tape to carry out the testing, but the properties listed are of the adhesive itself.

The conductive adhesives of this disclosure comprise a pressure sensitive adhesive composition. A wide range of pressure sensitive adhesive compositions are suitable. The pressure sensitive adhesive composition comprises at least one polymer or co-polymer. The pressure sensitive adhesive composition may comprise a blend or mixture of polymers and may include additional optional additives such a tackifying agents, plasticizing agents, fillers, and the like.

The at least one polymer or co-polymer of the pressure sensitive adhesive composition may be a linear or a block polymer or co-polymer and may comprise a wide range of monomeric constituents. Examples of suitable monomeric constituents include (meth)acrylates, polyolefins, polyurethanes, siloxanes, or combinations thereof.

Block co-polymer pressure sensitive adhesives can encompass a variety of pressure sensitive adhesives. Typically, block co-polymer pressure sensitive adhesives are of the A-B or A-B-A type, where A represents a thermoplastic aromatic block, often styrene, and B represents a rubbery block, typically polyisoprene, polybutadiene, or poly(ethylene/butylene). The block co-polymers can have a variety of architectures including linear, star, and comb configurations. A wide variety of such materials are available from Kraton Corporation, Houston, TX. Other block co-polymer pressure sensitive adhesives are also known such as (meth)acrylate block co-polymers (typically with methacrylate A blocks and acrylate rubbery B blocks) and siloxane block co-polymers as described below.

Generally, (meth)acrylate-based pressure sensitive adhesives are those that have a glass transition temperature that is less than room temperature, often −20° C. or less. Typically, the adhesive is a co-polymer that comprises 100 to 80 weight percent of C₃-C₁₂ alkyl ester component(s) such as, for example, iso-octyl acrylate, 2-ethyl-hexyl acrylate and n-butyl acrylate, and from 0 to 20 weight percent of a polar component such as, for example, acrylic acid, methacrylic acid, ethylene vinyl acetate, N-vinyl pyrrolidone and styrene. The (meth)acrylate pressure sensitive adhesives may be self-tacky or tackified and may be crosslinked.

Poly-olefin pressure sensitive adhesives generally comprise either a substantially uncrosslinked polymer prepared form olefinic monomers or an uncrosslinked polymer that may have radiation activatable functional groups grafted thereon as described in U.S. Pat. No. 5,209,971 (Babu, et al).

Polyurethane pressure sensitive adhesives useful in the invention include, for example, those disclosed in U.S. Pat. No. 3,718,712 (Tushaus); U.S. Pat. No. 3,437,622 (Dahl); and U.S. Pat. No. 5,591,820 (Kydonieus et al.).

Silicone pressure sensitive adhesives, also known as siloxane pressure sensitive adhesives, comprise two major components, a polymer or gum, and a tackifying resin. The polymer is typically a high molecular weight polydimethylsiloxane or polydimethyldiphenylsiloxane, that contains residual silanol functionality (SiOH) on the ends of the polymer chain, or a block co-polymer comprising polydiorganosiloxane soft segments and urea- or oxamide-terminated hard segments. Examples of urea-terminated hard segment siloxane block co-polymers are described for example in U.S. Pat. No. 5,214,119 (Leir, et al) and of oxamide-terminated hard segments are described for example in US 2008/0318058 (Sherman et al.). The tackifying resin is generally a three-dimensional silicate structure such as MQ resins.

As mentioned above, the pressure sensitive adhesive composition may comprise at least one modifying additive. Modifying additives are well known in the adhesive arts and can be optionally added if desired as long as they do not adversely affect the conductive properties of the conductive adhesive. Examples of suitable optional modifying additives include tackifying resins, plasticizing resins, reinforcing resin, antioxidants, stabilizers, or mixtures or combinations thereof.

The conductive adhesive further comprises electrically conductive particles dispersed within the pressure sensitive adhesive composition. A wide range of electrically conductive particles are suitable. The electrically conductive filler particles can be in the form of metallic particles or metal coated insulative (e.g., polymeric) particles or combinations thereof. In some embodiments, the electrically conductive particles comprise particles of nickel-coated graphite. The amount of electrically conductive particles present in the conductive adhesive can vary as will be described below. One particularly suitable conductive particle is the nickel-coated graphite particle “E-Fill #2806 Ni” commercially available from Oerlikon Metco, Westbury, NY.

The conductive adhesive further comprises an additive that comprises conductive nanoparticles. It was surprisingly found that the addition of a very small amount of such conductive nanoparticles can provide desirable improvements in the conductive adhesive. Among the improvements discovered by the addition of small amounts of conductive nanoparticles are improvements in conductivity and reduction in PIM.

Examples of suitable conductive nanoparticles include carbon nanotubes and metallic nanoparticles including nanowires, nanoflakes, nanograins, and nanospheres.

A carbon nanotube (CNT) is a tube made of carbon with diameters typically measured in nanometers. They are a relatively new class of materials and are becoming commercially available.

Single-wall carbon nanotubes (SWCNTs) are one of the allotropes of carbon, intermediate between fullerene cages and flat graphene, with diameters in the range of a nanometer to several nanometers. Although not made this way, single-wall carbon nanotubes can be idealized as cutouts from a two-dimensional hexagonal lattice of carbon atoms rolled up along one of the Bravais lattice vectors of the hexagonal lattice to form a hollow cylinder. In this construction, periodic boundary conditions are imposed over the length of this roll-up vector to yield a helical lattice of seamlessly bonded carbon atoms on the cylinder surface.

Multi-wall carbon nanotubes (MWCNTs) consist of nested single-wall carbon nanotubes weakly bound together by van der Waals interactions in a tree ring-like structure. Multi-wall carbon nanotubes are also sometimes used to refer to double- and triple-wall carbon nanotubes.

In some embodiments, the conductive nanoparticles comprise carbon nanotubes selected from: SWCNT (single-walled carbon nanotubes) or MWCNT (multi-walled carbon nanotubes); nickel nanowires; or a combination thereof. Typically, the carbon nanotubes or nickel nanowires are supplied in a solvent. A suitable commercial example of CNTs is the SWCNT “DM-NMP-0.4” (0.4% CNT dispersed in NMP) from Shanghai DM-Star Ltd. A suitable commercial example of nickel nanowires includes “NW-Ni-200-Alcohol” (0.5% nickel nanowires dispersed in alcohol) from Shanghai Jiaxin Ltd.

The conductive adhesive formulations can have a wide range of component compositions. In some embodiments, the conductive adhesive comprises:
50-95 parts by weight of the pressure sensitive adhesive composition;
5-50 parts by weight of electrically conductive particles; and
0.005-0.5 parts by weight of conductive nanoparticles.
   Parts by weight are used to describe these formulations instead of weight % as the weight components do not necessarily add up to 100.

In other embodiments, the conductive adhesive comprises:
70-90 parts by weight of the pressure sensitive adhesive composition;
10-30 parts by weight of electrically conductive particles; and
0.01-0.1 parts by weight of conductive nanoparticles.

As was mentioned above, the conductive adhesives have a wide range of desirable properties. Among these properties are adhesive properties (180° Peel Adhesion) and electrical properties (DC resistance and PIM). Each of these properties is described below.

The conductive adhesive is a pressure sensitive adhesive, meaning that has the features characteristic of a pressure sensitive adhesive: (1) aggressive and permanent tack, (2) adherence with no more than finger pressure, (3) sufficient ability to hold onto an adherend, and (4) sufficient cohesive strength to be cleanly removable from the adherend. One test commonly used to measure the adhesive properties of a pressure sensitive adhesives is 180° Peel Adhesion. In this test the adhesive is disposed on a backing and peeled from a test surface as described in the test method in the Examples section. In some embodiments, the conductive adhesive has a 180° Peel Adhesion of at least 10.0 Newtons/decimeter (0.10 N/mm) at Room Temperature when disposed on a 50-micromter thick PET (polyethylene terephthalate) backing.

The conductive adhesive also has desirable electrical properties. Among these properties are DC resistance and PIM. The conductive adhesive has a DC Resistance of less than or equal to 0.21 ohms as measured on a PIM board. The test method is described in the Examples section below. In some embodiments, the conductive adhesive has a DC Resistance of less than 0.15 ohms, or even less than 0.1 ohms.

Layers of adhesive are generally described as having length and width in the x-y plane and have a thickness along the z-axis. The conductive adhesives of this disclosure are generally “z-axis conductive adhesives”. By this it is meant that a layer of the adhesive conducts in the z-axis, which is the thickness of the layer of adhesive.

The adhesive layers of this disclosure can be prepared from the conductive adhesive compositions. The layers can be prepared by disposing the adhesive composition on the surface of a substrate such as a release liner. The adhesive layers can be provided in a variety of ways such as a sheet or as a roll, where the roll can be rolled upon itself for shipment or storage and unrolled when used.

Among the most surprising effects discovered for the conductive adhesives of the current disclosure is that the addition of a very small amount of conductive nanoparticles significantly reduces the PIM (passive intermodulation). Thus, when the PIM level is tested for the current conductive adhesives and compared to the same conductive adhesive without the conductive nanoparticles, the PIM level is reduced. PIM can be tested in a variety of ways as shown in the Figures.

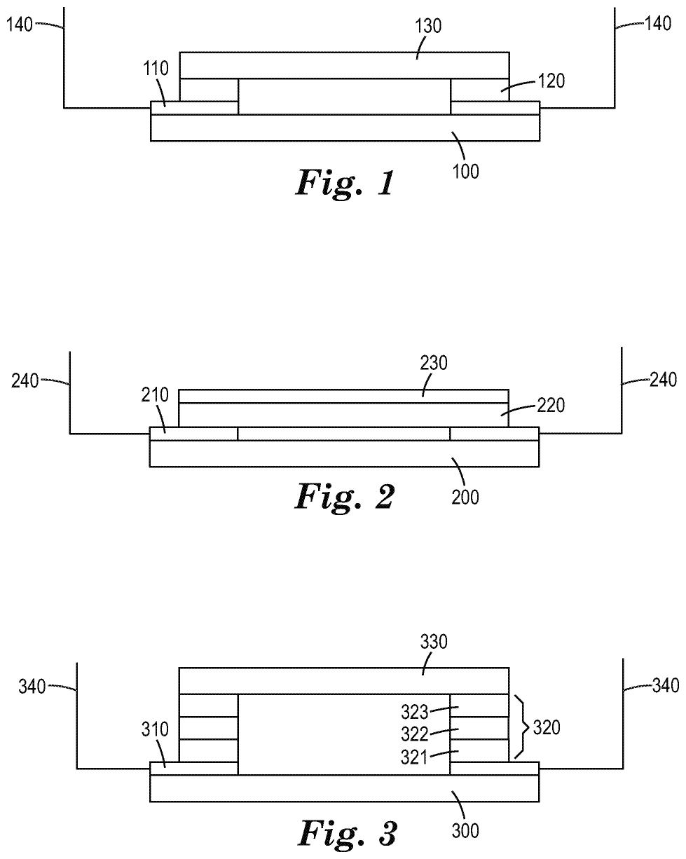

The Figures shows three methods for testing PIM. In the first method (FIG. 1), the adhesive itself is used. Samples of the adhesive are disposed on the gold portions of the PIM test board. The samples are connected by a conductive bridge, typically metal. Because the adhesive is a z-axis conductive adhesive, the adhesive samples form a conductive link between the gold portions and the conductive bridge. In FIG. 1, PIM test board 100 has gold portions 110 and wires 140. The test sample includes adhesive 120 with conductive bridge 130. In the second method (FIG. 2), the adhesive is formed into a single-sided tape with a conductive tape backing. This tape backing may be metallic or it may be a conductive woven or non-woven. The single-sided tape is disposed on and between the gold portions of the PIM test board such that the conductive adhesive is in contact with the gold portions. In this way, the conductive tape backing is serving as the conductive bridge. In FIG. 2, PIM test board 200 has gold portions 210 and wires 240. The test sample includes adhesive layer 220 with conductive tape backing 230. In the third method (FIG. 3), a double-side tape is used that comprises two layers of conductive adhesive with a conductive interlayer disposed between. The conductive interlayer may be a variety of conductive layers such as a metallic layer or a layer of conductive woven or non-woven. Samples of the double-sided tape are disposed on the gold portions of the PIM board, and a conductive bridge connects the samples. This configuration is very similar to that for the first method, except that the sample is a multi-layer sample of conductive adhesive/conductive interlayer/conductive adhesive instead of simply being the conductive adhesive. In FIG. 3, PIM test board 300 has gold portions 310 and wires 340. The test sample includes adhesive layer 320 with conductive bridge 330. Adhesive layer 320 has sublayers, these sublayers are sublayer 321 that is the adhesive sample, sublayer 322 is a conductive interlayer, and sublayer 323 is the adhesive sample.

It should be understood that the method of testing of the adhesive for PIM is not limiting on articles that can be made from the conductive adhesive but that regardless of how the PIM level is measured, the property is that of the conductive adhesive and not of articles of the adhesive (such a single-sided tapes, double-sided tapes and the like). One suitable method for measuring the PIM level of the conductive adhesive is that of the second method, where a single-sided tape is with an electrically conductive nonwoven tape backing comprising metal coated polymer fibers and placing the tape in the test fixture. When first and second electrical signals propagate in the thickness direction (z-axis) of the conductive adhesive layer at respective frequencies F1 and F2, any intermodulation signal generated has a frequency F3 equal to nF1+mF2, m and n positive or negative integers. When measured in this way, the measured PIM level is lower than in an identical conductive adhesive without the conductive nanoparticle additive.

Also disclosed herein are electrically conductive articles. In some embodiments, the electrically conductive article comprises a substrate with a first major surface and a second major surface, and an electrically conductive adhesive layer disposed on at least a portion of the second major surface of the substrate. The electrically conductive adhesive has been described in detail above. In some embodiments, the electrically conductive adhesive comprises a pressure sensitive adhesive composition, electrically conductive particles dispersed within the pressure sensitive adhesive composition, and at least one additive dispersed within the pressure sensitive adhesive composition, wherein the at least one additive comprises conductive nanoparticles. The conductive adhesive is a pressure sensitive adhesive with a DC Resistance of less than or equal to 0.21 ohms as measured on a PIM board and when tested for PIM (passive intermodulation) has a measured PIM level that is lower than the measured PIM level for an identical conductive adhesive without the additive. Methods for testing PIM are described above and in the Examples section.

A wide variety of substrates are suitable. In some embodiments, the substrate comprises an electrically conductive substrate. These embodiments can be described as “single-sided tapes” as they have a single side of exposed adhesive. A wide range of electrically conductive substrates are suitable. Examples of suitable conductive substrates include a nonwoven layer comprising metal coated polymer fibers, a woven fabric layer comprising metal coated polymer fibers, a film layer with metal coated surface(s), or a metal foil. Metal can be deposited on fibers or films in a wide variety of ways such as by coating, sputtering, electroplating, or chemical vapor deposition.

In other embodiments, the substrate comprises a release liner. In these embodiments, the conductive adhesive layer is a free-standing adhesive layer where both surfaces of the adhesive layer are exposed. These free-standing adhesive layers can be used in a wide variety of ways. The exposed adhesive surface can be laminated to a conductive substrate to form a single-sided tape as described above. The free-standing adhesive layer can be used as it is and laminated to a surface, the release liner can be removed to expose the second surface of the adhesive and a substrate or surface can be adhered to the newly exposed surface. The free-standing adhesive layer can also be laminated to the opposite surface of a single-sided adhesive tape as described above to form a double-sided adhesive tape.

Release liners are well understood in the adhesive arts as being layer articles from which adhesive compositions or coatings can be readily removed. Exemplary release liners include those prepared from paper (e.g., Kraft paper) or polymeric material (e.g., polyolefins such as polyethylene or polypropylene, ethylene vinyl acetate, polyurethanes, polyesters such as polyethylene terephthalate, and the like, and combinations thereof). At least some release liners are coated with a layer of a release agent such as a silicone, a fluorosilicone-containing material or a fluorocarbon-containing material.

### EXAMPLES

These examples are merely for illustrative purposes only and are not meant to be limiting on the scope of the appended claims. The following abbreviations are used: mm=millimeters; kg=kilograms; oz=ounces; MPa=MegaPascals; psi=pounds per square inch; dBm=decibel-milliwatts; MHz=MegaHertz; W=Watts.

Table of Abbreviations

| Abbreviation | Description |
|---|---|
| PSA-1 | Pressure sensitive adhesive-1, DS-4, (meth)acrylate in heptane solvent, |
| | available from 3M Company, St. Paul, MN |
| SIS-1 | Styrene-Isoprene-Styrene-1, a dissimilar arm, styrene-isoprene, star |
| | polymer with 9.2% styrene content and made according to |
| | U.S. Pat. No. Pat. No. 5,393,787, from Kraton Polymers US LLC, Houston, TX |
| HHR-1 | Hydrogenated Hydrocarbon Resin-1, available under the trade |
| | designation ARKON P125. From Arakawa Chemical Inc. |
| Resin-1 | Commercially available as TP2040 from Arizone Chemical |
| Resin-2 | Commercially available as GA90A from Arizona Chemical |
| Resin-3 | Thermoplastic resin end block reinforcer, available under the trade |
| | designation ENDEX 160, from Eastman Chemical Company |
| Crosslinker | Bisamide crosslinker from 3M Company |
| Conductive | Nickel coated graphite particles available as E-Fill #2806 Ni from |
| Particles | Oerlikon Metco |
| Nanoparticle-1 | Nickel nanowires, 0.5% nickel nano wires dispersed in alchol, |
| | available as NW-Ni-200-Alcohol from Shanghai Jiaxin Ltd. |
| Nanoparticle-2 | Carbon nanotubes, 0.4% CNT dispersed in NMP, available as |
| | DM-NMP-0.4% from Shanghai DM-Star Ltd. |
| Liner-1 | PET (polyethyleneterephthalate) liner, 75 micrometer thick C1S PET |
| | liner, from Hongqing Ltd. |
| Liner-2 | PET (polyethyleneterephthalate) liner, 50 micrometer thick C1S PET |
| | liner, from Hongqing Ltd |
| Fabric | Conductive fabric, commercially available as JX B1602P 16 |
| | micrometer thick, from Shanghai Jiaxin Ltd. |
| Foil-1 | Copper foil, 12 um ED copper foil, from Maitong Ltd. |
| Foil-2 | SUS foil, T0.05 304SUS foil, 0.05 millimeter thick, from Bomei Ltd. |
| Foil-3 | Aluminum foil, T0.1 aluminum foil, 0.1 millimeter thick 1060 |
| | aluminum foil, from Junxu Ltd. |
| EA | Ethyl Acetate from Peixing Chemical |
| HEP | Heptane from EMD Millipore |
| MEK | Methyl Ethyl Ketone from EMD Millipore |

### Test Methods

### Thickness Test

Test thickness was measured with a digital thickness tester 547-301 (manufactured by Mitutoyo).

### Electrical Tests

### Passive Intermodulation (PIM)

A test fixture, comprised of a 50 Ohm microstrip test board and mechanically connected coaxial cables, was used to measure PIM levels of the samples. The test board was 50 mm×80 mm×60 mil FR-4 dielectric with 1 oz copper having an ENIG (electroless nickel, immersion gold) finish. The microstrip line was 3 mm wide with a 10 mm gap centered along the board length to break the circuit. For samples E-1, E-2, CE-1, and CE-2 a single-sided tape (10 mm×30 mm) was formed and used (as shown in FIG. 2). After initial hand lamination to provide for two 3 mm×10 mm contact areas between the tape and the electrodes, a 2 kg rubber roller was applied across the tape. For samples E-3 and CE-3, a double-sided tape was formed and samples of the double-sided tape were attached to the gold electrodes, and the samples were linked with a stainless steel bridge (A 40 mm×3 mm×1 mm stainless steel 316L bridge was aligned to the samples and gap and connected using 0.103 MPa (15 psi) pressure, completing the electrical circuit) as shown in FIG. 3. The samples were left to dwell for at least twenty minutes before measurement. A Rosenberger desktop PIM analyzer (Tittmoning, Germany) was connected to the test fixture to perform the measurement. Two frequency signals between 729-758 MHz of 30 dBm (1 W) were swept over the LTE700L cellular band and the maximum reflected third order (IM3) value was recorded.

### Resistance Through PSA

After PIM test, the DC resistance between the electrodes was measured with a micro-ohm meter.

### EXAMPLES AND COMPARATIVE EXAMPLES

### General Procedures

### Preparation of Adhesive Mixtures

The mixing, coating and drying process of the PSA coated by solvent-based coating process in this invention is described below:

### Preparation of Adhesive Mixture A:

The adhesive polymer, resin and solvent (EA for Examples 1-2 and Comparative Examples C1-C2, and a 1:1 (by weight) mixture of MEK and HEP for Example 3 and Comparative Example C3) were weighed into a vessel. The mixture was mechanically mixed by a three-roller mixer until all solid parts were well dissolved.

### Preparation of Conductive Adhesive Mixture B:

The crosslinker (if applicable), conductive particle, and nano additive (if applicable) were added to the adhesive mixture A prepared above. The mixture was mechanically mixed by a stirring blade until all particles were well dispersed.

### Coating and Drying of the Adhesive

The conductive adhesive mixture B prepared above was coated by comma bar hand spread coater, with the comma bar set to the desired thickness, onto Liner-1. The coated wet conductive adhesive layer was dried at room temperature for 5 minutes and then in a 110° C. oven for 5 minutes. Liner-2 was laminated to the dried adhesive film.

### Examples 1-3 and Comparative Examples C1-C3

Conductive adhesive samples were prepared with the materials shown in Table 1 below using the general procedures described above. The Comparative Examples are the same composition of the Examples with the absence of the nanoadditives. Quantities of solvents were calculated to make a 20% solids solution in Examples 1-2 and Comparative Examples C1-C2 and a 30% solids solution in Example 3 and Comparative Example C3.

The formed adhesive layers were turned into double-sided tape samples by lamination to both sides of a substrate, either fabric, Foil-1, Foil-2, or Foil-3. The tape samples were tested for DC resistance and PIM, using the test methods described above. The results are presented in Table 2.

TABLE 1
Compositions

| | Example | Example | Example | Example | Example | Example |
|---|---|---|---|---|---|---|
| Component | 1 | 2 | 3 | C1 | C2 | C3 |
| PSA-1, dry weight (g) | 100 | 100 | — | 100 | 100 | — |
| SIS-1 (g) | — | — | 60 | — | — | 60 |
| HHR-1 (g) | — | — | 40 | — | — | 40 |
| Resin-1 (g) | 35.71 | — | — | 35.71 | — | — |
| Resin-2 (g) | — | 16.67 | — | — | 16.67 | — |
| Resin-3 (g) | — | — | 5 | — | — | 5 |
| Conductive particle (g) | 33.95 | 29.19 | 20 | 33.95 | 29.19 | 21.6 |
| Crosslinker, dry weight (g) | 0.085 | 0.085 | — | 0.085 | 0.085 | — |
| Nanoparticle-1, dry weight (g) | 0.034 | — | — | — | — | — |
| Nanoparticle-2, dry weight (g) | — | 0.015 | 0.034 | — | — | — |
| Nano-additive (wt %) | 0.02 | 0.01 | 0.02 | 0 | 0 | 0 |
| Solid content before coating (%) | 20 | 20 | 30 | 20 | 20 | 30 |
| Dry thickness (micrometers) | 20 | 20 | 20 | 20 | 20 | 20 |

TABLE 2
Resistance and PIM Measurements

| | | | Resistance | |
|---|---|---|---|---|
| Example | PSA Sample | Tape Backing | (Ohms) | PIM (dbm) |
| E-1A | E-1 | Fabric | 0.21 | −93.3 |
| CE-1A | CE-1 | Fabric | 0.40 | −73.3 |
| E-2A | E-2 | Fabric | 0.12 | −98.3 |
| CE-2A | CE-2 | Fabric | 0.17 | −84.6 |
| E-1B | E-1 | Foil-1 | 0.24 | −85.6 |
| CE-1B | CE-1 | Foil-1 | 0.32 | −74.4 |
| E-2B | E-2 | Foil-1 | 0.08 | −119.4 |
| CE-2B | CE-2 | Foil-1 | 0.09 | −112.9 |
| E-1C | E-1 | Foil-2 | 0.58 | −68.2 |
| CE-1C | CE-1 | Foil-2 | 0.64 | −62.4 |
| E-2C | E-2 | Foil-2 | 0.42 | −66.9 |
| CE-2C | CE-2 | Foil-2 | 0.56 | −61.9 |
| E-1D | E-1 | Foil-3 | 0.41 | −72.0 |
| CE-1D | CE-1 | Foil-3 | 0.59 | −62.5 |
| E-2D | E-2 | Foil-3 | 0.25 | −79.4 |
| CE-2D | CE-2 | Foil-3 | 0.52 | −65.8 |
| E-3A | E-3 | Fabric | 0.09 | −97.4 |
| CE-3A | CE-3 | Fabric | 0.14 | −91.1 |

What is claimed is:

1. A conductive adhesive comprising:
a pressure sensitive adhesive composition;
electrically conductive particles dispersed within the pressure sensitive adhesive composition; and
at least one additive dispersed within the pressure sensitive adhesive composition, comprising conductive nanoparticles;
wherein the conductive adhesive is a pressure sensitive adhesive with a DC Resistance of less than or equal to 0.21 ohms as measured as a tape with a conductive backing using a PIM board, and can be tested for passive intermodulation by forming a tape, the tape comprising a layer of the conductive adhesive and an electrically conductive layer, and placing the tape in a test fixture comprising gold conductive surfaces, and wherein when first and second electrical signals propagate in the thickness direction of the conductive adhesive layer between the gold surfaces at respective frequencies F1 and F2, any intermodulation signal generated from the first and second electrical signals having a frequency F3 equal to nF1+mF2, m and n positive or negative integers, has a PIM level that is lower than the identical conductive adhesive without the additive.

2. The conductive adhesive of claim 1, wherein when the conductive adhesive is disposed on a 50 micrometer thick polyethylene terephthalate backing has a 180° Peel Adhesion of at least 10.0 Newtons/decimeter at Room Temperature.

3. The conductive adhesive of claim 1, wherein the pressure sensitive adhesive composition comprises at least one polymer or co-polymer.

4. The conductive adhesive of claim 3, wherein the at least one polymer or co-polymer comprises a linear or block co-polymer comprising (meth)acrylates, polyolefins, polyurethanes, siloxanes, or combinations thereof.

5. The conductive adhesive of claim 1, wherein the electrically conductive particles comprise particles of nickel-coated graphite.

6. The conductive adhesive of claim 1, wherein the conductive nanoparticles comprise carbon nanotubes; metallic nanoparticles that are nanowires, nanoflakes, nanograins, or nanospheres; or a combination thereof.

7. The conductive adhesive of claim 6, wherein the conductive nanoparticles comprise carbon nanotubes selected from single-walled nanotubes or multi-walled nanotubes, nickel nanowires, or a combination thereof.

8. The conductive adhesive of claim 1, wherein the pressure sensitive adhesive composition comprises at least one modifying additive.

9. The conductive adhesive of claim 8, wherein the modifying additive comprises a tackifying resin, a plasticizing resin, a reinforcing resin, antioxidants, stabilizers, or mixtures or combinations thereof.

10. The conductive adhesive of claim 1, wherein the conductive adhesive comprises:
50-95 parts by weight of the pressure sensitive adhesive composition;
5-50 parts by weight of electrically conductive particles; and
0.005-0.5 parts by weight of additive conductive nanoparticles.

11. The conductive adhesive of claim 1, wherein the conductive adhesive comprises:
70-90 parts by weight of the pressure sensitive adhesive composition;
10-30 parts by weight of electrically conductive particles; and
0.01-0.1 parts by weight of additive conductive nanoparticles.

12. An electrically conductive article comprising:
a substrate with a first major surface and a second major surface; and
an electrically conductive adhesive layer disposed on at least a portion of the second major surface of the substrate; wherein the electrically conductive adhesive comprises:
a pressure sensitive adhesive composition;
electrically conductive particles dispersed within the pressure sensitive adhesive composition; and
at least one additive dispersed within the pressure sensitive adhesive composition,
wherein the at least one additive comprises conductive nanoparticles;
wherein the conductive adhesive is a pressure sensitive adhesive with a DC Resistance of less than or equal to 0.21 ohms as measured as a tape with a conductive fabric backing using a PIM board, and can be tested for passive intermodulation by forming a tape, the tape comprising a layer of the conductive adhesive and an electrically conductive layer, and placing the tape in a test fixture comprising gold conductive surfaces, and wherein when first and second electrical signals propagate in the thickness direction of the conductive adhesive layer between the gold surfaces at respective frequencies F1 and F2, any intermodulation signal generated from the first and second electrical signals having a frequency F3 equal to nF1+mF2, m and n positive or negative integers, has a PIM level that is lower than the identical conductive adhesive without the additive.

13. The electrically conductive article of claim 12, wherein the conductive pressure sensitive adhesive, when disposed on a 50 micrometer thick polyethylene terephthalate backing has a 180° Peel Adhesion of at least 10.0 Newtons/decimeter at Room Temperature.

14. The electrically conductive article of claim 12, wherein the substrate comprises an electrically conductive substrate.

15. The electrically conductive article of claim 14, wherein the electrically conductive substrate comprises a nonwoven layer comprising metal coated polymer fibers, a woven fabric layer comprising metal coated polymer fibers, a film layer with a metal coated surface, or a metal foil.

16. The electrically conductive article of claim 14, wherein the article further comprises a second layer of conductive adhesive disposed on the first major surface of the electrically conductive substrate.

17. The electrically conductive article of claim 12, wherein the substrate comprises a release liner.

18. The electrically conductive article of claim 12, wherein the pressure sensitive adhesive composition comprises at least one polymer or co-polymer comprising a linear or block co-polymer comprising (meth)acrylates, polyolefins, polyurethanes, siloxanes, or combinations thereof.

19. The electrically conductive article of claim 12, wherein the electrically conductive particles comprise particles of nickel-coated graphite.

20. The electrically conductive article of claim 12, wherein the conductive nanoparticles comprise carbon nanotubes; metallic nanoparticles that are nanowires, nanoflakes, nanograins, or nanospheres; or a combination thereof.

21. The electrically conductive article of claim 12, wherein the conductive adhesive comprises:
50-95 parts by weight of the pressure sensitive adhesive composition;
5-50 parts by weight of electrically conductive particles; and
0.005-0.5 parts by weight of additive conductive nanoparticles.
